(19) United States
(12) Patent Application Publication
(10) Pub. No.: US 2005/0282961 A1
(43) Pub. Date: Dec. 22, 2005

(54) Pressure-sensitive label laminates with improved convertability and broad temperature adhesion performance

(76) Inventors: Hsienkun Tsai, Macungie, PA (US); David C. Brown, Bethlehem, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(21) Appl. No.: 10/871,204

(22) Filed: Jun. 18, 2004

(51) Int. Cl. C08F 8/00

(52) U.S. Cl. 525/191

(57) ABSTRACT

This invention is directed to an improvement of the label convertibility of all temperature pressure sensitive adhesives based on acrylic emulsion. It maintains clarity in the final finished product after drying. It offers good broad and low temperature adhesion performance on wide range of substrates. The base polymer in the all temperature pressure sensitive adhesives is an acrylic emulsion polymer. The converting improvement resides in adding a vinyl acetate homopolymer and/or copolymers that will not increase the glass transition temperature of overall PSA that do not adversely impact to low temperature adhesion. The combination of unique features of this invention offers advantages for high-speed production in pressure sensitive label and tape industries.

### BACKGROUND OF THE INVENTION

Pressure sensitive adhesives (PSAs), which are tacky to the touch, are well known and widely used in industry and in consumer applications. The properties of the pressure sensitive adhesive are designed for specific applications, e.g., all temperature PSA where the pressure sensitive adhesive has good adhesion particularly at low temperatures, e.g., −20 F., clear to opaque and the like. Other pressure sensitive adhesives such as general purpose, cold temperature, freezer, and specialties can be found from the Handbook of Pressure Sensitive Adhesive Technology edited by Donatas Satas. They have different performance requirements in respect to application temperatures and service temperatures.

In a typical label construction, a pressure sensitive adhesive is coated onto a release liner and then pressure sensitive coated release liner is transferred and laminated onto a substrate often referred to as face stock. This process results in a standard three-layer label construction composed, then, of a face stock, a PSA, and a liner. The end product at this point is referred to as raw label stock.

Converting raw label stock which comprises operations such as slitting, printing, die-cutting, matrix stripping, sheeting, etc. into the final shapes and sizes of finished pressure sensitive products has presented significant challenges to the label and tape pressure sensitive industry for a long time. The cost of a finished pressure sensitive adhesive product is a function of raw material cost plus the processing cost. Hence, faster converting speeds are desired for the economic reasons. That is especially true for the blank label production that can run at converting speeds of 500-1000 feet per minute (fpm) with the equipment capability used by current converting industry.

The following patents and articles represent various pressure sensitive adhesive compositions and converting processes:

U.S. Pat. No. 5,663,228 discloses pressure sensitive adhesives having a mutually immiscible first elastomer, such as a styrene/acrylate copolymer and a second elastomer of a styrene-isoprene-styrene block elastomer exhibiting a glass transition temperature greater than the first.

U.S. Pat. Nos. 5,705,551 and 5,322,876 disclose the improvement in the cuttability of elastomeric pressure-sensitive adhesives; particularly of hot-melt tackified mutually immiscible elastomers based upon butadiene and isoprene. Block copolymer additives having hydrophilic and hydrophobic blocks such as polyethylene glycol wax or polypropylene oxide/polyethylene oxide copolymer are added to the elastomeric pressure-sensitive adhesives.

WO 01/96,488 A2 disclose adhesive tapes and labels having a laminate construction exhibit excellent adhesion to a variety of substrates and an ability to be converted at high speeds. The adhesive has at least two or more adhesive layers coated onto a face stock. At least one adhesive layer is compounded with an organopolysiloxane. A wide variety of elastomers, e.g., natural and synthetic elastomers, e.g., styrene and butadiene based polymers are representative of the adhesives.

U.S. Pat. No. 5,939,479, EP 0614473B1, and WO 93/10,177 disclose acrylic emulsion based adhesives modified by a wax and surfactant to produce removable, repositionable and guillotinable pressure sensitive compositions. Poylpropylene oxide-polyethylene oxide block copolymer non-ionic surfactants or wax emulsions and their mixtures are representative of the additives for the acrylic based adhesives.

U.S. Pat. No. 4,548,845 discloses polyethylene glycols (PEG) of various molecular weight of can be blended with tackified carboxylated styrene-butadiene rubber (SBR) latices such as Polysar PL-222 from Polysar or acrylic emulsions such as Gelva™ RA-3027 from Monsanto.

U.S. Pat. No.5,154,974 and WO 93/15,159 disclose the addition of additives based upon a silicone or polysiloxane to improve cutting properties in an acrylic emulsion PSA.

U.S. Pat. No.5,189,126 and WO 93/18,072 disclose the use of less than 1% of reactive multifunctional monomers having cyanurate or phosphate functionality in acrylic copolymers with less than 35% of 2-ethylhexyl acrylate in the total composition in order to enhance convertability and guillotine performance

EP 1,273,643 A1 (2003) disclose a blended acrylic PSA emulsions with one component comprised of a high glass transition temperature (Tg) polymer emulsion with an aqueous pressure sensitive adhesive polymer emulsion can be a good formulation option with different range of adhesion performance.

### BRIEF SUMMARY OF THE INVENTION

This invention is directed to an improvement of the convertibility of all temperature pressure sensitive adhesives based on emulsion polymerized acrylic polymers and maintain clarity of adhesive layer in the final product. The base polymer in the all temperature pressure sensitive adhesive is an acrylic emulsion polymer having a low Tg, e.g. less than −50° C. or preferably less than −60° C. The improvement resides in adding a vinyl acetate polymer having a Tg from 20° C. to 150° C. or preferably from 30° C. to 70° C. The vinyl acetate polymer preferably has a preselected particle size in the range of 100 nm to 1000 nm and preferably from 100 nm to 300 nm.

Significant advantages can be achieved and these include:

an ability to reduce edge ooze and adhesive build-up on the cutting and slitting devices/blades during converting;

an ability to deliver broad temperature adhesion performance while enhancing the cohesiveness;

an ability to increase bulk modulus for better die-cuttability and lower the release profile to improve the matrix strippability with less flagging and matrix breakge or process interuption;

an ability to improve low temperature adhesion performance down to −20° F. can be achieved on a wide range of substrates such as polyolefins and corrugated cardboard for packaging applications;

an abiity to produce clear all temperature acrylic based pressure sensitive adhesves after drying; and,

an ability to enhance polyolefin adhesion without addition of tackifiers or by using lower level of tackifiers compared to traditional formulated PSAs.

### DETAILED DESCRIPTION OF THE INVENTION

This invention is directed to an improvement of the convertibility of all temperature, emulsion polymerized acrylic pressure sensitive adhesives and maintain clarity in the final finished pressure sensitive adhesive product. It provides the potential for producing an economic label construction with higher productivity and equivalent adhesion performance by PSA design with proper dynamic mechanical viscoelasticity properties.

The base acrylic emulsion polymers for all temperature pressure sensitive adhesives are of conventional composition and comprised of polymerized units, in varying proportions, of the following soft monomers such as high alkyl acrylates having 4 to 12 carbon atoms in the alkyl group (i.e., octyl acrylate, 2-ethyl hexyl acrylate, butyl acrylate, and their mixtures), high alkyl methacrylates, (i.e., isobutyl methacrylate, n-dodecyl methacrylate, n-decyl methacrylate), high alkyl vinyl ester, hard monomers such as low alkyl methacrylates (i.e., methyl methacrylate), styrene, vinyl acetate, etc., functional monomers such as carboxylic acids (i.e., acrylic acid, methacrylic acid), dialkyl maleate, dialkyl fumarate, hydroxyl alkyl acrylate, and other organo-functional acrylate/methacrylate etc., multifunctional crosslinking monomers.

The overall glass transition temperature for the all temperature pressure sensitive adhesive typically is defined by the mid-point glass transition temperature (Tg) measured by a differential scanning calorimeter at 20° C./min. scan rate. The Tg is in the range of −80° C. to −50° C. and preferably in the range of −70° C. to −55° C. The insoluble fraction of the all temperature acrylic based pressure sensitive adhesive in THF can range from 0 to 100% but preferably is within the range of 40% to 80%.

The all temperature acrylic pressure sensitive adhesives can be prepared by either thermal and redox initiation emulsion polymerization at 50-100° C. reaction temperatures with the total solids contents from 45% to 75% and the gel content (i.e., THF or toluene insoluble measured by solvent extraction) from 40% to 80%. The molecular weight and molecular weight distribution of the soluble fraction of the polymer is typically controlled by the initiator level and the amount of chain transfer agent used. The protective colloidal systems are conventional and mainly based on ionic and non-ionic surfactants and their combinations. The useful particle size and particle size distribution is typically in the range of 100 to 1000 nm with either single or multi-modal distribution.

To enhance convertibility of the pressure sensitive adhesive and maintain clarity of the final product has been a difficult assignment. A wide variety of additives have been added in the past to achieve adhesion improvement over a broad temperature range, enhance convertibility. But, to maintain clarity in the final product and achieve good adhesion at low temperature, i.e., −20 F., with excellent convertibility has remained a challenge.

It has been found that a small amount of modifier incompatible with the base acrylic emulsion polymer can achieve such result. The incompatible modifier is a vinyl acetate polymer such as Vinac® 828M, from Air Products Polymers, when used in an amount of from 1 to 10% and preferably in the range of 4 to 8% by weight of the base acrylic polymer (dry weight basis). Higher levels of vinyl acetate polymer tend to reduce the low temperature performance of the pressure sensitive adhesive.

The vinyl acetate polymer can contain a small amount of co-monomers, e.g., up to about 50% by weight but such commoners should be selected so as to not dramatically affect the overall glass transition temperature of the pressures sensitive adhesive. Changes can result in reduced clarity of the pressure sensitive adhesive or reduced low temperature properties and the like. The average particle size of the incompatible modifier is in the range of 100 to 1000 nm and preferably in the range of 100-300 nm. The glass transition temperature of these modifiers should have at least one high Tg domain from 20° C. to 150° C. and preferably in the range of 30° C. to 105° C.

Silicone and silicone-organic-polymers and other lubricants, adhesion promoters including tackifier resin dispersion for improving polyolefin adhesion, and block copolymer surfactants for improving low temperature adhesion might provide additional values. Tackifiers suited for use preferably have a Ring & Ball softening point from 0° C. to 150° C. and preferably from 25° C. to 90° C. Examples include a tackifier dispersion based on rosin acid, rosin ester, hydrocarbon resin, terpene phenolic resin or their hybrids/blends.

The following examples are intended to represent various embodiments of the invention and are not intended to restrict the scope thereof.

### CONTROL EXAMPLE 1

Three formulated commercial pressure sensitve adhesives (PSAs) with different base polymers were transfer-coated with 20-21 grams per square meter coating weights from 40# SCK siliconized liner to the 50# semi-gloss facestock paper. Consequently, their converting property was evaluated on a label converting machine #1 (model 4120 from Mark Andy) using a rotary-die #1 with four rectangular (1″ by 3.5″) engraved cavities layout across the web. The converting properties were compared by the die-cuttability and matrix strippability. Two stages of failure modes were observed; first, the flagging speeds as measured by feet per minute (fpm) with the loose hanger and ultimately, speeds with flag transfering as measured by feet per minute (fpm) or the waste matrix breakage.

| | | | | | Flag |
|---|---|---|---|---|---|
| | | Glass | Molec- | Initial | trans- |
| | | transisition | ular | flag | fering |
| PSA | | temeperature | weight | speeds | speeds |
| Designation | Base Polymers | (Tg)* | (MW) | (fpm) | (fpm) |
| PSA-1A | Flexcryl ® | −60° C. | low | 50 | 775 |
| (control) | 1624 | | | | |
| PSA-1B | Flexcryl ® | −60° C. | medium | 250 | 840 |
| | 1624/1627(1:1) | | | | |
| PSA-1C | Flexcryl ® | −55° C. | high | 250 | 835 |
| | 1624/1625(1:1) | | | | |

Flexcryl ® acrylic polymers are products suppllied by Air Products Polymers LLP.
*The glass transition temperature (Tg) measured by the differential scanning calorimeter at 20° C./min. scan rate.

The data show increasing the molecular weight of Flexcryl® 1624 from Air Products Polymers base polymer by blending with a higher molecular weight and the same glass transition temperature (Tg) polymer such as Flexcryl® 1627 in a 1:1 ratio showed some improvement in converting while maintaining equivalent low temperature adhesion performance as shown from the comparison of examples PSA-1B vs. PSA-1A. Increasing the molecular weight and Tg of Flexcryl® 1624 by blending with a higher molecular weight and higher Tg of secondary polymer such as Flexcryl® 1625 has some improvement in converting but the low temperature adhesion decreased as shown from the comparison of examples PSA-1C vs. PSA-1A, presumably since its Tg increases.

### COMPARATIVE EXAMPLE 2

Three formulated PSAs with different base polymers were transfer-coated with 20-21 grams per square meter coating weights from 40# SCK siliconized liner to the 60# semi-gloss facestock paper. Consequently, their converting property was evaluated on a label converting machine #1 using a rotary-die #1 with four rectangular (1″ by 3.5″) and a rotary-die #2 with a single rectangular (1″ by 14″) engraved cavities layout across the web. Both dies were manufactured by Rotometrics. The converting properties were compared by the die-cuttability and matrix strippability. Two stages of failure modes are observed; first, the flagging speed with the loose hanger and ultimately, speeds with flag transfering as measured by feet per minute (fpm) or the waste matrix breakage. They converted equally or non-differentiated from die #1 and with slightly different from die #2.

| | | Glass | | | Flag |
|---|---|---|---|---|---|
| | | transition | Molec- | Initial | trans- |
| | | temper- | ular | flag | fering |
| PSA | | ature* | weight | speeds | speeds |
| designation | Base polymers | (Tg) | (MW) | (fpm) | (fpm) |
| PSA-2A | Flexcryl ® | −60° C. | low | 130 | 870 |
| (control) | 1624 | | | | |
| PSA-2B | Flexcryl ® | −60° C. | high | 180 | 960 |
| | 1627 | | | | |
| PSA-2C | Flexcryl ® | −60° C. | low | 170 | 960 |
| | 1624 + 2% | | | | |
| | SM2163 | | | | |

The data show that increasing the molecular weight and maintaining the Tg such as Flexcryl® 1627 vis-á-vis Flexcryl® 1624 showed some improvement in converting on die #2 while maintaining equivalent low temperature adhesion performance as shown from the comparison of examples PSA-2B vs. PSA-2A. Modification of PSA-2A with a 2% additive such as the silicone emulsion, SM2163 from GE Silicone, has some improvement in converting problably due to the contribution in release control yet it has slightly inferior room temperature adhesion on recycled corrugated cardboard (CC), see comparisons of examples PSA-2C vs. PSA-2A.

| Adhesion Performance* | PSA-2A | PSA-1B | PSA-2B | PSA-2C |
|---|---|---|---|---|
| CC Peel @ 23° C. (pli) | 1.1 | 1.0 | 1.1 | 1.0 |
| HDPE Peel @ 23° C. (pli) | 0.9 | 0.8 | 0.8 | 1.0 |
| CC looptack @ 23° C. (pli) | 1.6 | 1.6 | 1.6 | 1.2 |
| HDPE looptack @ 23° C. (pli) | 2.2 | 2.2 | 2.2 | 2.6 |
| HDPE looptack @ 15° C. (pli) | 2.0 | 2.0 | 1.8 | 2.1 |
| HDPE looptack @ 5° C. (pli) | 2.2 | 2.2 | 2.0 | 2.3 |
| HDPE looptack @ −5° C. (pli) | 2.3 | 2.5 | 2.2 | 2.6 |
| HDPE looptack @ −15° C. (pli) | 1.4 | 1.6 | 1.4 | 1.0 |
| HDPE looptack @ −25° C. (pli) | 0.4 | 0.3 | 0.4 | 0.3 |

*Peel and looptack performance were measured by PSTC-101 and PSTC-16, respectively.

### COMPARATIVE EXAMPLE 3

Four formulated PSAs, with the same base polymers and different level of modifier such as Vinac® 828M from Air Products Polymers, were transfer-coated with 20-21 grams per square meter coating weights from 40# SCK siliconized liner to the 60# semi-gloss facestock paper. Consequently, their converting property was evaluated on a label converting machine #1 (model 4120 from Mark-Andy) using a rotary-die #2 (supplied by Rotometrics) with a single rectangular (1″ by 14″) engraved cavities layout across the web. The converting properties were compared by the die-cuttability and matrix strippability. Two stages of failure modes are observed; first, the flagging rate or speed with the loose hanger and ultimately, converting speeds with flag transfering. The degree of edge ooze was also observed by surface tack rating.

| | | | | | Flag |
|---|---|---|---|---|---|
| | | Glass | | Initial | trans- |
| | | transition | | flag | fering |
| PSA | | temperature | Edge | speeds | speeds |
| designation | Base polymers | (Tg) | ooze | (fpm) | (fpm) |
| PSA-3A | Flexcryl ® | −60° C. | Yes | 90 | 130 |
| (control) | 1624 | | | | |
| PSA-2B | Flexcryl ® | −60° C. | Yes | — | 180 |
| | 1627 | | | | |
| PSA-3B | Flexcryl ® | −60° C. | No | — | 420 |
| | 1627 + 6% | | | | |
| | Vinac ® 828M | | | | |
| PSA-3C | Flexcryl ® | −60° C. | No | 130 | 550 |
| | 1627 + 10% | | | | |
| | Vinac ® 828M | | | | |

Vinac ® 828 M is vinyl aceatate homopolymer supplied by Air Products Polymers, LLP.

The data show increasing the molecular weight and maintaining the same Tg showed limited improvement in converting from machine #1 with die #2 as shown from the comparison of examples PSA-2B (based on Flexcryl® 1627) vs. PSA-3A (based on Flexcryl® 1624). Modification of PSA-2B with different level of polyvinyl acatate emulsion such as Vinac® 828M showss significant improvement in convertability due, it is believed, to the contribution in modulus and release control as shown from the comparison of examples PSA-3B/PSA-3C vs. PSA-2B. Increasing the modifier level provided the means to enhance convertability. Yet, the trade off in adhesion performance at low temperature such as −20° C. or below and at room temperature might be noticeable when the modifier level is higher than 10%.

| Adhesion Performance* | PSA-3A | PSA-2B | PSA-3B | PSA-3C |
|---|---|---|---|---|
| CC Peel @ 23° C. (pli) | 1.2 | 1.1 | 1.3 | 0.9 |
| HDPE Peel @ 23° C. (pli) | 1.3 | 1.4 | 1.4 | 0.8 |
| CC looptack @ 23° C. (pli) | 1.6 | 1.6 | 1.8 | 0.9 |
| HDPE looptack @ 23° C. (pli) | 2.3 | 2.2 | 2.6 | 2.0 |
| HDPE looptack @ 5° C. (pli) | 2.2 | 2.2 | 2.0 | 2.3 |
| HDPE looptack @ −15° C. (pli) | 2.0 | 2.1 | 1.9 | 2.6 |

*Peel and looptack performance were measured by PSTC-101 and PSTC-16, respectively.

### EXAMPLE 4

Three formulated PSAs with the same base polymers but different additives were transfer-coated with 20-21 grams per square meter coating weights from 40# SCK siliconized liner to the 50# semi-gloss facestock paper. Two additives were included here, a silicone emulsion such as SM2163 from GE Silicone, and a polyvinyl acetate emulsion such as Vinac® 828M from Air Products Polymers. Consequently, their converting property was evaluated on a label converting machine #2 (model T330 from SIAT) using a rotary-die #3 (supplied by Rotometrics) with four rectangular (1″ by 3.375″) engraved cavities layout across the web. The converting properties were compared by the die-cuttability and matrix strippability. Two stages of failure modes were observed; first, the flagging rate or speed with the loose hanger and ultimately, speeds with flag transfering or the waste matrix breakage. The degree of edge ooze was also observed by surface tack rating.

| | | | | Flag | |
|---|---|---|---|---|---|
| | | | | transfering | |
| PSA | Base | | Flag | speeds | Edge |
| designation | polymers | Additives | rate | (fpm) | ooze |
| PSA-4A | Flexcryl ® | none | Yes | 560 | Yes |
| (control) | 1624 | | | | |
| PSA-4B | Flexcryl ® | 2.5% SM2163 | No | 640+ | No |
| | 1624/additive | | | | |
| PSA-4C | Flexcryl ® | 2.5% SM2163 | No | 640+ | No |
| | 1624/additives | and 5% | | | |
| | | Vinac ® 828M | | | |

+exceed the top speed with converting machine #2

Additives such as a silicone emulsion, a polyvinyl acetate emulsion, and their combination can enhance converting properties such as reduce flag rate and increase stripping speed. PSA-4B was modified with 2.5% SM2163 from PSA-4A and PSA-4C was modified with 2.5% SM2163 and 5% Vinac® 828M. Also, the edge ooze can be improved significantly.

### EXAMPLE 5

Three formulated PSAs with the same base polymers but different additives were transfer-coated with 20-21 grams per square meter coating weights from 40# SCK siliconized liner to the 50# semi-gloss facestock paper. Two additives were included here, a polyvinyl acetate emulsion such as Vinac® 828M from Air Products Polymers and a tackifier dispersion such as Snowtack™ 880G from Eka Nobel. Consequently, their converting property was evaluated on a label converting machine #2 (model T330 from SIAT) using a rotary-die #3 (supplied by Rotometrics) with four rectangular (1″ by 3.375″) engraved cavities layout across the web. The converting properties were compared by the die-cuttability and matrix strippability. Two stages of failure modes were observed; first, the flagging rate with the loose hanger and ultimately, speeds with flag transfering or the waste matrix breakage. The degree of edge ooze was also observed by surface tack rating.

| | | | | Flag | |
|---|---|---|---|---|---|
| | | | | transfering | |
| PSA | Base | | Flag | speeds | Edge |
| designation | polymers | Modifiers | rate | (fpm) | ooze |
| PSA-5A | Flexcryl ® | none | high | 650+ | Yes |
| (control) | 1624 | | | | |
| PSA-5B | Flexcryl ® | 15% Vinac ® | low | 660+ | No |
| | 1627/additive | 828M | | | |
| PSA-5C | Flexcryl ® | 15% Vinac ® | low | 660+ | No |
| | 1627/additives | 828M + 15% | | | |
| | | Snowtack ™ | | | |
| | | 880G | | | |

+exceed the top speed with the converting machine #2

It is worth mentioning that PSA-5B and PSA-5C provide converting improvements with less flagging and edge ooze problems compared to the control PSA-5A. However, the high level of Vinac® 828M in PSA-5B causes poor adhesion at room temperature and low temperature especially on the rough or uneven surfaces such as corrugated cardboard. Yet, PSA 5C has poor low temperature adhesion and good room temperature adhesion due to the presence of tackifier resulting in higher Tg adhesive. Both of them will not satisfy the requirements of an all temperature PSA and yet they can be considered for broader temperature general purpose PSA applications.

### EXAMPLE 6

Four formulated PSAs, PSA-6A a commercial all-temp PSA such as Flexcryl® ATA supplied by Air Products Polymers, PSA-6B a commercial general purpose permanent GPP PSA such as Flexcryl® GP-6W supplied by Air Products Polymers, PSA-6C a commercial tackified general purpose PSA such as Flexcryl® 560H supplied by Air Products Polymers, and PSA-6D an developmental all-temp PSA were transfer-coated with 20-21 grams per square meter coating weights from 40# SCK siliconized liner to the 50# semi-gloss facestock paper. Two additives were included here, a polyvinyl acetate emulsion such as Vinac® 828M from Air Products Polymers and a tackifier dispersion such as Snowtack™ 880G from Eka Nobel. Consequently, their converting property was evaluated on a label converting machine #2 (model T330 from SIAT) using a rotary-die #4 (supplied by Rotometrics) with a single rectangular (0.9375″ by 11 ″) engraved cavities layout across the web. The converting properties were compared by the die-cuttability and matrix strippability. Two stages of failure modes were observed; first, the flagging rate or speed with the loose hanger and ultimately, speeds with flag transfering or the waste matrix breakage. The degree of edge ooze was also observed by surface tack rating.

| | | | | Flag |
|---|---|---|---|---|
| | | | | transfering |
| PSA | Base | | Edge | speeds |
| Designation | polymers | Modifiers | ooze | (fpm) |
| PSA-6A | Flexcryl ® | none | Yes | 100 |
| (control) | 1624 | | | |
| PSA-6B | Flexcryl ® | none | Yes | 375 |
| | 1625 | | | |
| PSA-6C | Flexcryl ® | Snowtack ™ 880G | Yes | 350 |
| | 1625/additive | | | |
| PSA-6D | Flexcryl ® | 10% Vinac ® 828M | No | 410 |
| | 1627/additive | | | |

Effects of polymer grade and tackifier on improving label converting were demonstrated when PSA-6A was replaced by PSA-6B (with a higher Tg base polymer, Flexcryl® 1625) and PSA-6C (with a higher Tg base polymer and a tackifier). Unfortunately, these two higher Tg PSAs can be used only for general purpose permanent (GPP) applications which require limited low temperature adhesion performance in the range of 20 to 40° F. Suprisingly, PSA-6D (with a low Tg polymer and a polyvinyl acetate modifier at 10% addtion level) provides the best converting properties among these four PSAs while providing good low temperature, i.e., −10° F., adhesion similar to PSA 6A. Surprisingly too, it that PSA -6D is clear.

### EXAMPLE 7

Five formulated PSAs, PSA-7A a commercial all-temp PSA such as Flexcryl® ATA supplied by Air Products Polymers, PSA-7B, 7C, 7D, and 7E were developmental PSAs and they were transfer-coated with 20-21 grams per square meter coating weights from 40# SCK siliconized liner to the 50# semi-gloss facestock paper. Two additives were included here, a polyvinyl acetate emulsion such as Vinac® 828M from Air Products Polymers and a tackifier dispersion such as Snowtack™ 880G from Eka Nobel. Consequently, their converting property was evaluated on a label converting machine #2 (model T330 from SIAT) using a rotary-die #4 (supplied by Rotometrics) with a single rectangular (0.9375″ by 11″) engraved cavities layout across the web. The converting properties were compared by the die-cuttability and matrix strippability. Two stages of failure modes were observed; first, the flagging speed/frequency with the loose hanger and ultimately, speeds with flag transfering or the waste matrix breakage. The degree of edge ooze was also observed by surface tack rating.

| | | | | | Flag |
|---|---|---|---|---|---|
| | | | | | transfering |
| PSA | Base | | Edge | Flag | speeds |
| designation | polymers | Modifiers | ooze | rate | (fpm) |
| PSA-7A | Flexcryl ® | none | high | high | 650+ |
| (control) | 1624 | | | | |
| PSA-7B | Flexcryl ® | none | med- | med- | 670+ |
| | 1627 | | ium | ium | |
| PSA-7C | Flexcryl ® | 10% Vinac ® | low | low | 650+ |
| | 1627/additive | 828M | | | |
| PSA-7D | Flexcryl ® | 15% Vinac ® | low | low | 660+ |
| | 1627/additive | 828M | | | |
| PSA-7E | Flexcryl ® | 15% Vinac ® | low | low | 660+ |
| | 1627/additives | 828M + 15% | | | |
| | | Snowtack | | | |
| | | 880G | | | |

+exceed the top speed with converting machine #2

Effects of polymer grade and additives on improving label converting were demonstrated from the flagging rate and edge ooze instead of max running speeds since they all were capable to run at the top speeds of converting machine #2 without matrix breakage or hanger transfer. PSA-7B was slightly better than PSA-7A due to the difference in base polymer. Yet, additional converting benefits were illustrated by PSA-7C, 7D, and 7E with proper modifiers. The addition of a polyvinyl acetate emulsion, such as Vinac® 828M at 10-15% level in PSA-7C and 7D, respectively, improves the converting properties. The extra tackifier loading with Snowtack™ 880G at 15% level on top of 15% Vinac® 828M in PSA-7E still maintained excellent converting properties. Both PSA-7D and 7E were designed for broader adhesion performance general purpose PSA applications. PSA-7B and 7C were considered for all-temp PSA applications. Although converting PSA's at high levels of polyvinyl acetate addtiion levels, e.g., 15%, low temperatue performance is sacrificed and they are not suitable for all temperature applications.

In summary, the improvements of label converting properties have been demonstrated from the paper label construction using a rotary die-cutting device, yet their benefits are expected to be useful in other constructions such as facestocks other than paper and liners other than siliconized release paper. Converting improvement can be contributed to two mechnaisms—first, the increase of bulk physical properties such as increase storage modulus improves the die-cutting speed and sencondly, the reduction of release properties especially at high peel rate improves the matrix strippability. Also the low Tg fraction of acrylic domain is not altered by the presence of incompatible organic fillers/modifiers, and therefore it can deliver low temperature adhesion performance.

Modification of traditional pressure sensitive adhesives with organic polymers without increase of glass transition temperatures but increase of the plateau modulus has resulted in unique adhesives with much improved label converting properties such as increase cohesiveness/shear, reduce edge ooze, lower flagging frequency, and increase stripping speed.

1. In an all temperature acrylic emulsion based polymer pressure sensitive adhesive, the improvement which comprises:
a vinyl acetate polymer present in an amount from about 1 to 10% by weight of said pressure sensitive adhesive on a dry basis.

2. The pressure sensitive adhesive of claim 1 wherein the acrylic emulsion based polymer is a 2-ethyl hexyl acrylate (2-EHA) homopolymer or copolymer.

3. The pressure sensitive adhesive of claim 1 wherein the acrylic emulsion based polymer has a Tg in the range of −50° C. to −80° C.

4. The pressure sensitive adhesive of claim 3 wherein the acrylic emulsion based polymer has polymerized units of 2-ethyl hexyl acrylate from 70% to 100%.

5. The pressure sensitive adhesive of claim 2 wherein the acrylic emulsion based polymer has the number average particle size from 100 nm to 1000 nm.

6. The pressure sensitive adhesive of claim 1 wherein the Tg of the vinyl acetate copolymer is from 30° C. to 70° C.

7. The pressure sensitive adhesive of claim 6 wherein the vinyl acetate polymer is a homopolymer or copolymer containing from 50% to 100% vinyl acetate.

8. The pressure sensitive adhesive of claim 6 wherein the vinyl acetate polymer has a number average particle size from 100 nm to 300 nm.

9. The pressure sensitive adhesive of claim 6 wherein said vinyl acetate polymer is added in an amount from about 4% to 8% by weight of said pressure sensitive adhesive on a dry basis of polymer.

10. The pressure sensitive adhesive of claim 1 wherein the pressure sensitive adhesive includes a tackifier dispersion from 0% to 30% by weight of said pressure sensitive adhesive on a dry basis of polymer.

11. The pressure sensitive adhesive of claim 10 wherein the pressure sensitive adhesive includes a tackifier dispersion having a the Ring & Ball softening point from 25° C. to 90° C.

12. The pressure sensitive adhesive of claim 10 wherein the pressure sensitive adhesive includes a tackifier dispersion based on rosin acid, rosin ester, hydrocarbon resin, terpene phenolic resin or their hybrids/blends.

13. The pressure sensitive adhesive of claim 1 wherein the pressure sensitive adhesive includes optionally a silicone polymer from 0% to 5% by weight of said pressure sensitive adhesive on a wet basis of polymer.

14. The pressure sensitive adhesive of claim 13 wherein the pressure sensitive adhesive includes a silicone polymer.

15. The pressure sensitive adhesive of claim 1 wherein the insoluble fraction in THF is from 40% to 80%.
